(19) United States
(12) Patent Application Publication
(10) Pub. No.: US 2025/0361809 A1
(43) Pub. Date: Nov. 27, 2025

(54) COATING SYSTEM REMOVAL METHOD

(71) Applicant: Rolls-Royce plc, London (GB)

(72) Inventor: Mehrzad DELFAN-AZARI, Derby (GB)

(73) Assignee: ROLLS-ROYCE plc, London (GB)

(21) Appl. No.: 19/191,503

(22) Filed: Apr. 28, 2025

(30) Foreign Application Priority Data
May 24, 2024 (GB) 2407399.1

(51) Int. Cl. F01D 5/00; B24C 1/04; C23G 1/14

(52) U.S. Cl. CPC F01D 5/005; B24C 1/04; C23G 1/14; F05D 2230/80

(57) ABSTRACT

A method of removing a coating system from a component that is coated with the coating system. The method involves: (a) immersing the component in a caustic solution; (b) maintaining the component in the caustic solution at atmospheric pressure for a time ≤1.5 hours at a temperature ≥150° C. and ≤250° C.; (c) removing the component; (d) rinsing the component in water; (e) water jet blasting the component to remove the ceramic top coat layer and any thermally-grown oxide; (f) immersing the component in an acid solution; (g) ultra-high pressure water jetting the component; (h) aluminising the component to convert any diffused Pt within the bond coat layer to Pt—Al; (i) acid stripping and grit blasting the component; (j) immersing the component in a solution of nitric acid and/or sulphamic acid; and (k) ultra-high pressure water jetting the component to remove any Pt—Al.

### CROSS-REFERENCE TO RELATED APPLICATIONS

This specification is based upon and claims the benefit of priority from United Kingdom patent application number GB 2407399.1 filed on May 24, 2024, the entire contents of which is incorporated herein by reference.

### BACKGROUND

### Technical Field

The present disclosure relates to a coating system removal method, more particularly a method of removing a coating system from a component that is coated with the coating system, e.g. a gas turbine engine component.

### Description of the Related Art

Components of various machines are typically coated to protect them during use, e.g. to minimise wear and generally improve their safe and useful life. Gas turbine aircraft engine components, particularly those located in gas paths of such engines, are required to withstand extreme temperatures and abrasive contacts for prolonged periods of time and maintaining their integrity can be critical to the safety of everyone aboard.

Such components are typically manufactured at great cost from specialised materials, e.g. titanium alloys, which are protected by a specialised coating system and must meet strict standards to merit safe use. Freshly manufactured components that do not conform to those strict standards are rejected for use. Components that no longer conform to those strict standards through use are repaired or replaced. Scrapping non-conforming components is undesirable for commercial and resource conservation reasons so ideally non-conforming components should be repaired.

Repairing a component that is protected by a specialised coating system typically involves removing some or all of the coating system. If the component is not worn or otherwise damaged, i.e. the coating system has provided an effective protection during use, repairing or replacing the coating system may be sufficient for the component to conform to the relevant conformance standards. If the component is worn or is otherwise damaged, the component will need to be repaired before repairing or replacing the coating system.

Various methods for removing coatings from components are known but they tend to only partially remove one or more coatings and/or can damage the component in the process. When a coating system is only partially removed further work tends to be undertaken to remove the remaining coating system, which typically involves treating the component with more potent agents that can increase the risk of the damaging the component. When a component has been damaged in the process of coating system removal the component must either be repaired, typically at significant cost and effort, or more often scrapped and replaced.

The present disclosure provides a coating system removal method that overcomes at least some of the aforementioned problems or at least provides a useful alternative to known coating system removal method.

### SUMMARY

According to a first aspect there is provided method of removing a coating system from a component that is coated with the coating system, the method comprising the steps of:
(a) immersing the component in a caustic solution of 46 to 54% potassium hydroxide or 46 to 54% sodium hydroxide;
(b) maintaining the component in the caustic solution at atmospheric pressure for a time equal to or less than one and a half hours at a temperature equal to or greater than 150° C. and equal to or less than 250° C.;
(c) removing the component from the caustic solution;
(d) rinsing the component in water;
(e) water jet blasting the component by directing water at the ceramic top coat layer from a nozzle at a pressure of 275 to 296 MPa (40,000 to 43,000 psi), arranging the nozzle at a stand-off distance from the ceramic coating of 25 to 40 mm and traversing the nozzle over the ceramic top coat layer at a speed of 4 to 8 mm per second to remove the ceramic top coat layer and any thermally-grown oxide;
(f) immersing the component in an acid solution;
(g) ultra-high pressure water jetting the component;
(h) aluminising the component to convert any diffused Pt within the bond coat layer to Pt—Al;
(i) acid stripping and grit blasting the component;
(j) immersing the component in a solution of nitric acid and/or sulphamic acid; and
(k) ultra-high pressure water jetting the component to remove any Pt—Al formed in step (h).

In some embodiments, any machined surfaces and/or any internal surfaces of the component are masked before the component is immersed in the acid solution in step (f) and the machined surfaces of the component are demasked before the component is ultra-high pressure water jet washed in step (g).

In some embodiments, the acid solution used in step (f) is a hydrochloric acid solution.

In some embodiments, the component is heat tinted after step (g) to indicate that all intermetallic material has been removed.

In some embodiments, in step (h) any diffused Pt within the bond coat layer is converted to Pt—Al by pack aluminising the component for 10 to 30 hours at 700° C. to 1050° C.

In some embodiments, in step (h) the component is pack aluminised for 16 to 22 hours at 800° C. to 950° C.

In some embodiments, in step (h) the component is heat tinted to indicate that all aluminised material has been removed.

In some embodiments, any machined surfaces and/or any internal surfaces of the component are masked before the component is aluminised in step (h) and the machined surfaces of the component are demasked before the component is ultra-high pressure water jet washed in step (k).

In some embodiments, in step (i) the component is immersed in hydrochloric acid at 40 to 60° C. for 5 to 15 minutes, and optionally subsequently immersed in an ammonium solution to neutralise the acid.

In some embodiments, in step (i) the component is grit blasted using a 220 mesh alumina grit at 0.14 MPa (20 psi).

In some embodiments, in step (j) the component is immersed in a solution of nitric acid for 20 to 40 minutes at 30° C. to 60° C., and optionally subsequently immersed in an ammonium solution to neutralise the acid.

In some embodiments, in step (j) the component is immersed in a solution of sulphamic acid for 20 to 40 minutes at 30° C. to 60° C., and optionally subsequently immersed in an ammonium solution to neutralise the acid.

In some embodiments, in step (j) the component is immersed in a solution of nitric acid and sulphamic acid for 20 to 40 minutes at 30° C. to 60° C., and optionally subsequently immersed in an ammonium solution to neutralise the acid.

In some embodiments, following step (k) the component is heat tinted to indicate that all of the coating system has been removed.

In some embodiments, the component is heat tinted at 700 to 800° C. for up to 20 minutes.

In some embodiments, the component is a gas turbine engine component.

In some embodiments, the gas turbine engine component is a high pressure turbine blade or a high pressure nozzle guide vane.

According to a second aspect there is provided method of repairing a component that is coated with a coating system, the coating system comprising a bond coat layer and a ceramic top coat layer, the method comprising the steps of: (i) removing the coating system from the component by the method of the first aspect; and (ii) reapplying the coating system to the component to repair the component.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

The term “coating system” as used herein means a protective coating, e.g. for a component, where the protective coating comprises a plurality of coatings, at least two of those coatings being a different material. The coating system comprises at least one bond coat layer and a ceramic top coat layer. In some embodiments the coating system includes a thermally-grown oxide (TGO) coat layer that has grown between the ceramic top coat layer and the bond coat layer.

The term “component” as used herein means a part of a machine. The component may be provided with a protective coating, e.g. in the form of a coating system. The component may be a gas turbine engine component, e.g. a gas turbine aircraft engine component. The component is formed from a base material, for example a titanium-based superalloy or a nickel-based superalloy.

The term “removing” as used herein means removing entirely or at least substantially entirely.

The terms “ceramic top coating” or “ceramic top coating layer” as used herein refer to thermally insulating material of a coating system that is applied to a component that enables the component to withstand elevated temperatures during use. It is the outermost layer of a coating system. In some embodiments, the thermally insulating material consists of or comprises yttria-stabilized zirconia.

The terms “thermally-grown oxide (TGO) coating” or “thermally-grown oxide (TGO) coat layer” as used herein is part of a thermal barrier coating that grows at the interface of the ceramic top coating and the bond coating. It typically comprises alumina or aluminium oxides.

The terms “bond coating” or “bond coat layer” as used herein refers to the material of a coating system that is applied to the base material. It is the innermost layer or layers of a coating system, i.e. it provides the foundation upon which the coating system is built. In some embodiments the material is an oxidation and corrosion-resistant metal alloy (e.g. a NiCrAlY alloy or a NiCoCrAlY alloy), aluminising (alum), platinum aluminising (Pt—Al), or a combination of any of these.

The term “base material” as used herein means the material from which the component is formed. The base material provides the substrate upon which the coating system is applied. In some embodiments the base material is a superalloy, for example a titanium-based alloy or a nickel-based alloy.

The term “superalloy” as used herein means a metal alloy that its able to operate under high fractions of its melting point. Such an alloy typically has high durability, mechanical strength, thermal resilience, and longevity. Superalloys include titanium-based alloys such as Ti-6Al-4V alloy, Ti-6Al-2Sn-4Zr-2Mo alloy, Ti-5Al-2Sn-2Zr-4Cr-4Mo alloy, and Ti-10V-2Fe-3Al alloy and nickel-based alloys such as 80Ni-20Cr alloy.

The term “MCrAlY alloy” as used means an alloy of chromium (Cr), aluminium (Al), yttrium (Y) and a metal “M” typically selected from cobalt and/or nickel. Such alloys are typically used as bond coats or corrosion resistant overlays in thermal barrier coatings for gas turbine engine components, e.g. turbine blades and nozzle guide vanes. Chromium and aluminium form protective oxides while yttrium helps as a stabilising element in those oxides. The choice of M typically depends on the primary corrosion mechanism. As engine temperatures increase cobalt tends to be selected as M.

The term “thermal barrier coating” as used herein is a thermally insulating material that is applied to the surface of a component that is required to operate at elevated temperatures. Such coatings can allow for higher operating temperatures while limiting the thermal exposure of structural components, extending component life by reducing oxidation and thermal fatigue.

Throughout this specification and in the claims that follow, unless the context requires otherwise, the word “comprise” or variations such as “comprises” and “comprising”, will be understood to imply the inclusion of a stated integer or group of integers but not the exclusion of any other stated integer or group of integers.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

### BRIEF DESCRIPTION OF THE DRAWINGS

Embodiments will now be described by way of example only, with reference to the Figures, in which:

FIG. 1 is a sectional side view of a turbofan gas turbine engine;

FIG. 2 is a perspective view of high pressure nozzle guide vane of a gas turbine engine;

FIG. 3 is a flow chart showing the steps of the coating system removal method of the present disclosure; and

FIG. 4 is a flow chart showing the steps of the component repair method of the present disclosure.

### DETAILED DESCRIPTION

Aspects and embodiments of the present disclosure will now be discussed with reference to the accompanying figures. Further aspects and embodiments will be apparent to those skilled in the art.

In a first aspect the present disclosure provides a method of removing a coating system from a component that is coated with the coating system. The method removes the coating system entirely or substantially entirely without damaging the component. It also simplifies the subsequent repair of the component by simply re-applying the desired coating system to component.

### The Coating System

The coating system, which provides a protective coating for the component, can take various forms but comprises at least one bond coat layer and a ceramic top coat layer. In some embodiments the coating system includes a thermally-grown oxide (TGO) coat layer that has grown between the ceramic top coat layer and the bond coat layer.

### The Component

The component is a part or a machine and can take various forms. The component may be provided with a protective coating, e.g. in the form of a coating system as mentioned above. The component may be a gas turbine engine component, e.g. a gas turbine aircraft engine component, for example a turbine blade or a nozzle guide vane. The method of the present disclosure was developed in particular for removing the coating system from gas turbine aircraft engine components that are required to withstand extreme temperatures in use, for example high pressure turbine blades and high pressure nozzle guide vanes.

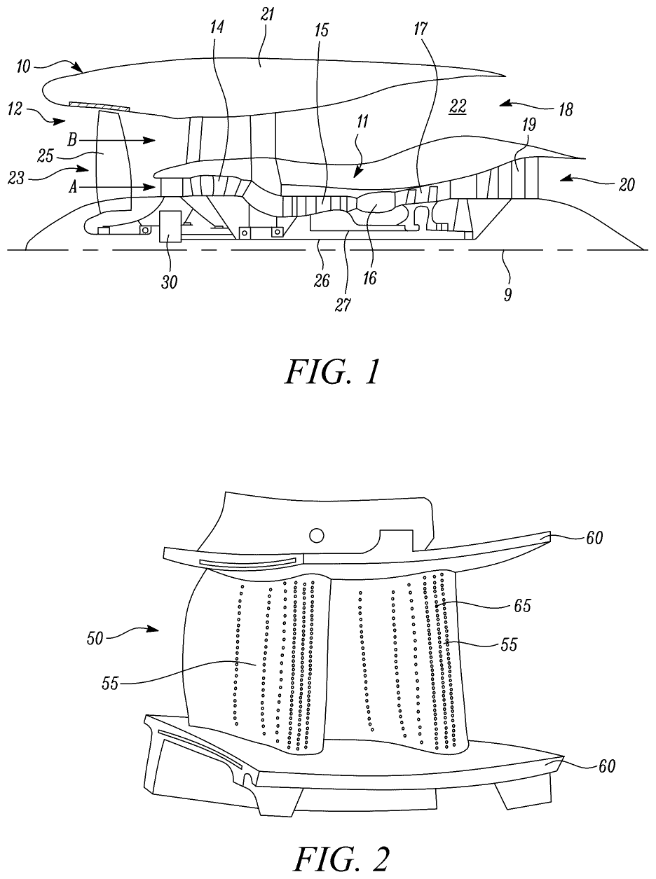

FIG. 1 illustrates a gas turbine engine 10 having a principal rotational axis 9. The engine 10 comprises an air intake 12 which receives air and a propulsive fan 23 generates two airflows: a core airflow A and a bypass airflow B. Air intake airflow comprises the sum total of the air flowing into the operational upstream end of the engine 10, with the sum total of the core airflow A and the bypass airflow B substantially equal to the intake airflow.

The gas turbine engine 10 comprises a core 11 that receives the core airflow A. The engine core 11 comprises, in axial flow series, a low pressure compressor 14, a high-pressure compressor 15, combustion equipment 16, a high-pressure turbine 17, a low pressure turbine 19 and a core exhaust nozzle 20. A nacelle 21 surrounds the gas turbine engine 10 and defines a bypass duct 22 and a bypass exhaust nozzle 18. The bypass airflow B flows through the bypass duct 22. The fan 23 is attached to and driven by the low pressure turbine 19 via a shaft 26 and an epicyclic gearbox 30.

In use, the core airflow A is accelerated and compressed by the low pressure compressor 14 and directed into the high pressure compressor 15 where further compression takes place. The compressed air exhausted from the high pressure compressor 15 is directed into the combustion equipment 16 where it is mixed with fuel and the mixture is combusted. The resultant hot combustion products then expand through, and thereby drive, the high pressure and low pressure turbines 17, 19 before being exhausted through the nozzle 20 to provide some propulsive thrust. The high pressure turbine 17 drives the high pressure compressor 15 by a suitable interconnecting shaft 27. The fan 23 generally provides the majority of the propulsive thrust. The epicyclic gearbox 30 is a reduction gearbox.

Various components in such a gas turbine engine are required to withstand extreme temperatures for prolonged periods of time. The safety of the passengers and crew who fly in aircraft powered these gas turbine engines depends on this.

FIG. 2 shows one such component in the form of a high pressure nozzle guide vane. The high pressure nozzle guide vane 50 has a pair of aerofoils 55 that are supported between a pair of platforms 60. A plurality of cooling holes 65 are formed in each of the aerofoils.

The component is typically manufactured from a superalloy, typically a single crystal, and covered by coating system to protect its integrity during use. For present purposes the coating system removal method of the present disclosure is described with reference to high pressure nozzle guide vanes but the skilled person will appreciate that the method is readily applicable to other gas turbine engine components and indeed components generally.

High pressure nozzle guide vanes are examples of gas turbine aircraft components that have a complex shape and include intricate features such as cooling holes of various shapes and sizes. The coating system removal method is able to remove the coating system from some features too.

### Coating System Removal Method

According to a first aspect there is provided method of removing a coating system from a component that is coated with the coating system, the coating system comprising a bond coat layer and a ceramic top coat layer, the method comprising the steps of:
(a) immersing the component in a caustic solution of 46 to 54% potassium hydroxide or 46 to 54% sodium hydroxide;
(b) maintaining the component in the caustic solution at atmospheric pressure for a time equal to or less than one and a half hours at a temperature equal to or greater than 150° C. and equal to or less than 250° C.; (c) removing the component from the caustic solution;
(d) rinsing the component in water;
(e) water jet blasting the component by directing water at the ceramic top coat layer from a nozzle at a pressure of 275 to 296 MPa (40,000 to 43,000 psi), arranging the nozzle at a stand-off distance from the ceramic coating of 25 to 40 mm and traversing the nozzle over the ceramic top coat layer at a speed of 4 to 8 mm per second to remove the ceramic top coat layer and any thermally-grown oxide;
(f) immersing the component in an acid solution;
(g) ultra-high pressure water jetting the component;
(h) aluminising the component to convert any diffused Pt within the bond coat layer to Pt—Al;
(i) acid stripping and grit blasting the component;
(j) immersing the component in a solution of nitric acid and/or sulphamic acid; and
(k) ultra-high pressure water jetting the component to remove any Pt—Al formed in step (h).

The method combines chemical stripping and ultra-high pressure water jetting for the effective removal of a metallic bond coating (e.g. MCrAlY and Pt—Al).

By using ultra-high pressure water jetting it is possible to minimise the use of grit blasting and hence reduce the likelihood of eroding the base material of the component.

The individual steps of the coating system removal method will now be described in more detail with references to certain illustrative embodiments.

Step (a) involves immersing the component in a caustic solution of 46 to 54% potassium hydroxide or 46 to 54% sodium hydroxide.

Step (b) involves maintaining the component in the caustic solution at atmospheric pressure for a time equal to or less than one and a half hours at a temperature equal to or greater than 150° C. and equal to or less than 250° C. The caustic solution is understood to permeate through the ceramic coating and weaken the thin TGO layer that tends to grow at the interface of the ceramic top coating and the bond coating.

Step (c) involves removing the component from the caustic solution.

Step (d) involves rinsing the component in water, e.g. at ambient temperature. This is understood to produce a thermal shock that further weakens the bond between the ceramic top coat layer and the bond coat layer.

Step (e) involves water jet blasting the component by directing water at the ceramic top coat layer from a nozzle at a pressure of 275 to 296 MPa (40,000 to 43,000 psi), arranging the nozzle at a stand-off distance from the ceramic coating of 25 to 40 mm and traversing the nozzle over the ceramic top coat layer at a speed of 4 to 8 mm per second to remove the ceramic top coat layer.

In some embodiments the water is directed at the ceramic top coat layer from a nozzle at a pressure of 275 to 296 MPa (40,000 to 43,000 psi), through a cylindrical or conical orifice fitted into a nozzle, at 75° to 90° orientation, at 900-1000 rotation, arranging the nozzle at a stand-off distance from the ceramic coating of 25 to 40 mm and traversing the nozzle over the ceramic top coat layer at a speed of 4 to 8 mm per second, choreographed in an array of intricate manner to ensure good coverage and effective removal of the ceramic top coating from the gas washed surfaces of the component.

Having conducted step (e) it is useful to inspect the component, e.g. at least visually, for any remnant ceramic top coating. If any such remnants are found another waterjet stripping cycle will typically be sufficient to remove them.

Steps (a) to (e) are based on the method for removing a ceramic coating from a ceramic coated metallic article, e.g. a gas turbine engine component, which is described in European patent EP 3708697 B1, the contents of which is incorporated herein by reference. EP 3708697 B1 further describes that when one portion of a ceramic coated metallic article is more than another portion of the ceramic coated metallic article one can adjust the manner in which each of those portions is water jet blasted to optimise the removal of the ceramic coating.

Steps (a) to (e), particularly step (e), will also remove any thermally-grown oxide (TGO) coat layer that has grown at the interface of the ceramic top coating and the bond coating. Such a TGO coat layer typically comprises aluminide oxides and is typically thin, e.g. has an average thickness of 0.25 to 1.5 μm.

Having removed the ceramic top coating of the coating system the bond coat layer will now be exposed, any defects in the bond coat layer can be more clearly identified, and the bond coat is ready to be removed down to the base material of the component via a series of acid stripping, de-smutting, grit blasting and ultra-high pressure water jetting steps.

The bond coat layer of a coating system for a gas turbine engine component is typically a metallic layer or it includes a metallic layer to enhance the oxidation or corrosion resistance of the component that is coated with the coating system. However a particular challenge for removing a coating system that includes a metallic layer is to remove that metallic layer from the component without damaging the base material of the component as the base material is often also metallic.

The metal to be removed from the bond layer can be one or more of various metals or alloys of various metals. When the component is a gas turbine engine component the metallic layer is typically a MCrAlY alloy, e.g. a CoCrAlY alloy or a NiCrAlY alloy. The metallic layer, which is typically 25 to 225 μm thick, must meet strict standards i.e. being void of non-conforming features such as pits and spits, delamination, poor adhesion, erosion, oxidation, contamination, high porosity, lower surface roughness, over spray on machine aerofoils and machine surface. The method of the present disclosure can remove the metal layer together with the rest of the coating system so that the component can be suitably repaired rather than scrapped.

In some embodiments, in preparation for the acid stripping step to follow it is useful to clean the component with the metal layer exposed, i.e. to remove any foulants (e.g. grease, staining, soluble constituent, and insoluble dirt) from the external and any internal surfaces of component to reduce subsequent acid solution contamination; and/or to mask any internal core passages and machined surfaces (e.g. using wax material or lacquer).

In some embodiments, it may be useful to grit blast any MCrAlY bond coat surfaces of the component to remove any residual oxide. Having done so it may be useful to inspect any masking and repair any damage to that masking.

Step (f) involves immersing the component in an acid solution to begin to remove the bond coat layer. The choice of acid will depend on the composition of the bond coat layer. When the bond coat layer comprises a metallic layer, e.g. a MCrAlY alloy, the acid solution is a hydrochloric acid (HCl) solution. Such an acid treatment can reduce MCrAlY intermetallic bond coating cohesion strength and thereby assist in the removal of a MCrAlY alloy from the bond coat layer of the coating system.

In some embodiments, once the component has been acid stripped the bond coat layer is de-smutted, i.e. any residual material is removed. The de-smutting can be carried out using any suitable method, for example grit blasting. In some embodiments, where necessary the component may be subjected to a series of cycles of being immersed in an acid solution and optionally de-smutted. The component may be submerged in a neutralisation tank and rinsed to remove residual acid between cycles to aid safe handling.

In some embodiments, where any internal core passages and machined surfaces of the component were masked in preparation for the acid stripping step, step (f), the internal core passages and machined surfaces of the component can be demasked after step (f) and any de-smutting is complete. The demasking may typically involve removing any wax material or lacquer that was used for the masking.

Step (g) involves ultra-high pressure water jetting the component. This is intended to remove any intermetallic material in the bond coating layer. The skilled person can determine the relevant ultra-high pressure water jetting parameters for the suitable equipment employed, e.g. water jet pressure, stand-off distance, traverse speed, nozzle orifice type, nozzle rotation and choreography of nozzle movements on the component surfaces, and the composition of the bond coating layer. Ultra-high pressure water jetting it is less likely to damage the component than grit blasting.

In some embodiments, where the bond coating layer includes a MCrAlY bond coating, the component may be ultra-high pressure water jetted by directing water at the MCrAlY coating surfaces from a cylindrical or conical orifice of the nozzle at a pressure of 275 to 296 MPa (40,000 to 43,000 psi), at 30-45° orientation, at 900-1000 rotation, arranging the nozzle at a stand-off distance from the ceramic coating of 30 to 40 mm and traversing the nozzle over the MCrAlY bond coating layer at a speed of 3 to 5 mm per second to remove the MCrAlY bond coating from the component.

Having conducted step (g) it is useful to inspect the component, e.g. at least visually, for any remnant MCrAlY bond coating. If any such remnants are found one option can be to repeat step (g) as that will typically be sufficient to remove them. Alternatively, in some embodiments, the component may be heat tinted to indicate that there is no remnant MCrAlY bond coating. In any event it is highly desirable to have removed any remnant MCrAlY bond coating before continuing the coating removal method of the present disclosure.

In some embodiments, in preparation for the aluminising step to follow it is useful to clean the component and/or to mask any internal core passages and machined surfaces (e.g. using wax material or lacquer).

Step (h) involves aluminising the component to convert any diffused Pt within the bond coat layer to Pt—Al.

Some components, particularly gas turbine engine components, are electro-plated with platinum to enhance their oxidation and corrosion resistance. If the bond coating is to be Pt—Al, the electro-plating typically involves applying a platinum layer of an average thickness of 5 to 8 μm. If the bond coating is to be diffused Pt only, then an average thickness of 12 μm of platinum is typically applied during electro-plating in the green (as coated) state. The platinum layer is then heat treated to form a diffused Pt bond coat layer.

The inventor has found one can more effectively chemically strip any diffused Pt within the bond coat layer when it is converted to platinum aluminide beforehand.

Diffused Pt can be converted to Pt—Al in various ways.

In some embodiments, the component is pack aluminised to convert any diffused Pt within the bond coat layer to Pt—Al. Pack aluminising is a thermo-chemical diffusion process, where Al or Cr is mixed with aluminium oxide and an activator, typically comprising one or more of an activating agent, sodium fluoride (NaF), ammonium chloride (NH₄Cl) and sodium chloride (NaCl), in a sealed container. The container is placed in an inert chamber, heated to a high temperature so the activator produces a metal halide vapor, and the metal halide vapor is subsequently transported and deposited on the component being coated. With sufficient exposure time at the high temperature, a coating thickness of 30 μm to 70 μm is typically achieved. The high temperature is typically from 750° C. to 1050° C., or from 800° C. to 950° C., for example 875° C. The exposure time is typically from 10 hours to 30 hours, or from 16 hours to 22 hours, for example 20 hours. The aluminised component is typically cleaned, e.g. using a fibre brush, suction apparatus or clean compressed air, and then the surfaces of the aluminised component are typically inspected to ensure conformity to component definition and the relevant component specific quality standard.

In some embodiments, diffused Pt within the bond coat layer on a component is converted to Pt—Al by gas aluminising and chemical vapour deposition.

In some embodiments, the aluminised component may be heat treated to homogenise the coating structure. The heat treatment may be at 1050° C. to 1150° C., for example 1100° C., and may be for 60 to 90 minutes, for example 60 minutes. The component is typically grit blasted to remove oxide, e.g. using 220 mesh alumina grit particles at about 0.14 MPa (20 psi), and then inspected to check that the gas washed surfaces of the component has been effectively cleaned of oxide.

Where necessary or desirable, certain parts of the component such as machine surfaces, non-gas washed surfaces and seal slots may be suitably protected throughout this and the subsequent chemical stripping step.

Step (i) involves acid stripping and grit blasting the component. This is intended to remove any metal within the bond coat layer.

In some embodiments, the acid stripping involves immersing the component in hydrochloric acid or nitric acid, for example at specific gravity (SG) of 1.16 to 1.46 at 40° C. to 50° C. for 10 to 20 minutes. The acid stripped component may be washed in cold water (e. for 2 minutes) to remove excess acid, immersed in an ammonium solution (e.g. 1-2% for about one minute) to neutralise the acid, and washed again in cold water (e.g. for about 2 minutes).

The grit blasting can be achieved using any suitable equipment and manner for the component concerned. In some embodiments the component is grit blasted using a 220 mesh alumina grit at 0.14 MPa (20 psi). If necessary the component can be de-smutted i.e. any excess alloyed metal removed (e.g. using SCOTCH-BRITE™ non-woven hand pads commercially available from 3M) between cycles of grit blasting.

If necessary step (g) can be repeated, e.g. once, twice, three times, four times, five times or six times, until the metal layer has been completely removed. Once the metal layer has been completely removed any masking can also be removed, e.g. by immersing the component in boiling water for about 30 minutes followed by heat tinting in air circulating furnace at 700° C. for up to 20 minutes.

Step (j) involves immersing the component in a solution of nitric and/or sulphamic acid. This is intended to remove any remaining aluminised material within the bond coat layer.

In some embodiments, the component is immersed in a nitric acid (HNO₃) solution, e.g. at 1.42 SG. The component may be immersed in the nitric acid solution for 20 to 40 minutes, e.g. 30 minutes, at 30° C. to 60° C., e.g. 40° C. to 50° C.

In some embodiments, the component is immersed in a sulphamic acid (NH₂SO₃H, aka amidosulfonic acid) solution, e.g. at a concentration of 45 to 50 g/l. The component may be immersed in the sulphamic acid solution for 20 to 40 minutes, e.g. 30 minutes, at 30° C. to 60° C., e.g. 40° C. to 50° C.

In some embodiments, the component is immersed in a solution of nitric acid and sulphamic acid, e.g. a nitric and sulphamic acid solution of one volume of (100 ml) nitric acid at 1.42 SG, nine volumes of demineralised water (900 ml) and then 50 g of sulphamic acid. The component may be immersed in such a nitric and sulphamic acid solution for 20 to 40 minutes, e.g. 30 minutes, at 30° C. to 60° C., e.g. 40° C. to 50° C.

In some embodiments, after the has been immersed in the solution of nitric and/or sulphamic acid, the component is washed in cold water is used to remove excess acid (e.g. for 5 to 10 minutes), the component is immersed in an ammonium solution (e.g. 1 to 2% for 5 to 10 minutes) to neutralise the acid, and the component is washed again in cold water (e.g. for 5 to 10 minutes).

If necessary the component can be grit blasted to de-smut the component i.e. remove any excess aluminised material or alloyed metal from gas washed surfaces or from surface features such as cooling holes. The grit blasting can be achieved using any suitable equipment and manner for the component concerned.

In some embodiments the component is grit blasted using a 220 mesh alumina grit, e.g. at 0.14 MPa (20 psi) for gas washed surfaces or at 0.14 to 0.21 MPa (20 to 30 psi) for surface features such as cooling holes.

Step (k) involves ultra-high pressure water jetting the component to remove any Pt—Al formed in step (h). The skilled person can determine the relevant ultra-high pressure water jetting parameters for the suitable equipment employed, e.g. water jet pressure, stand-off distance, traverse speed, nozzle orifice type, nozzle rotation and choreography of nozzle movements on the component surfaces, and the composition of the bond coating layer. Ultra-high pressure water jetting it is less likely to damage the component than grit blasting.

In some embodiments, the component may be heat tinted to remove any residual Pt—Al. In such embodiments, the component may be heat tinted in an air circulating furnace at 700° C. to 800° C., e.g. about 700° C., for up to 20 minutes.

Having completed steps (a) through (k) it is useful to inspect the component at least visually to check that the coating system has been removed. If necessary step (k) can be repeated to remove any remnants of the coating system.

One will typically conduct one or more metallurgical assessments to check that the component has not been damaged during the coating system removal method e.g. any of the surfaces of the component are pitted or otherwise damaged.

The coating system removal method removes the coating system entirely or substantially entirely without damaging the component. This is important for the subsequently repaired component to meet the strict standards that are required to merit safe use. If any of the coating system remains on the component once the coating system removal method has been completed, the component will require further processing before it is suitable for the coating system to be repaired in the component repair method. Such processing is typically time and cost intensive. If the component is damaged in any way, that damage would need to be suitably repaired before the component is suitable for the coating system to be repaired in the component repair method with any prospect of meeting the necessary conformance standards. Such repairs are typically time and cost intensive. The scrapping of any components is undesirable for commercial and also resource conservation reasons, especially when the component, like many gas turbine engine components, and even the coating system contains critical metals (e.g. nickel or titanium) or minerals.

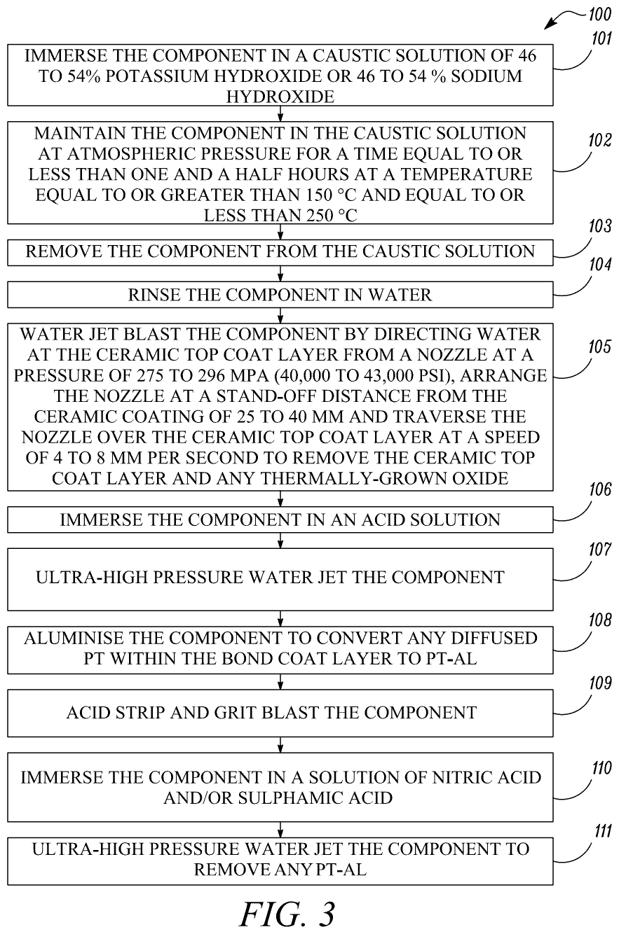

FIG. 3 is a flow chart that summarises the steps (101-111) of the coating system removal method (100) of the present disclosure that are described above.

### Component Repair Method

In a second aspect the present disclosure provides a method of repairing a component that is coated with a coating system, the coating system comprising a bond coat layer and a ceramic top coat layer. The method comprises the steps of: (i) removing the coating system from the component by the method of the first aspect; and (ii) reapplying the coating system to the component to repair the component.

In step (i) the method of the first aspect is used to remove or substantially remove the coating system from the component. The success of this step enables the repair to be subsequently effected by step (ii), i.e. without having to treat the component any further to remove the coating system and risk damaging the component in the process.

In step (ii) the coating system can be reapplied to the component in any suitable manner to repair the component. This can be achieved for example by; Aluminising (Alum), diffused platinum (Pt), Pt—Al, Low Vacuum Plasma Spray (LVPS), High Velocity Oxygen Fuel coating (HVOF), air plasma spraying (APS) or electron beam physical vapor deposition (EB-PVD).

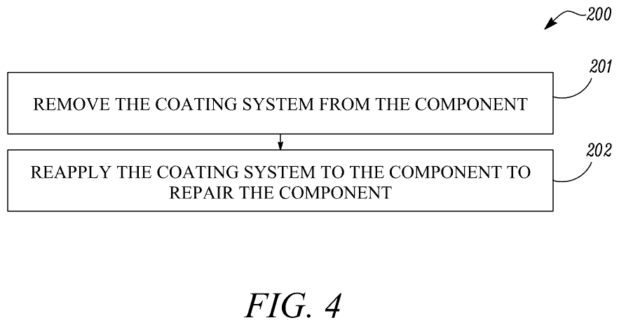

FIG. 4 is a flow chart that summarises the steps (201, 202) of the component repair method (200) of the present disclosure that are described above.

There are various means known in the art by which the component can be assessed to meet production standards and to merit safe use. These include visual inspection, dye penetration inspection, dimensional measurements and comparative assessments to the original casting conditions, air flow measurements, and various laboratory assessments and functional testing (i.e. furnace cyclic testing) for specific types of components.

Advantages of the methods

The methods of the present disclosure offer various technical advantages. Whilst many of have been described above, in summary such advantages include:
The coating removal method enables the coating system to be removed entirely or at least substantially entirely from the component without damaging the component.
The coating system removal method avoids or at least minimises any additional processing steps to remove the coating system from the component, which tend to be time and cost intensive. .
The coating system removal method avoids or at least minimises any additional steps to repair damage to the component caused by removing the coating system, which tend to be time and cost intensive.
The coating removal method is able to remove the coating system from a component that has a complex shape and may have intricate features such as cooling holes of various shapes and sizes on its surface.
The coating system removal and coating repair methods minimise the scrapping of components that do not meet strict conformance standards to merit safe use, thereby conserving the use of resources including critical metals, precious metals, rare earth materials and minerals.

It will be understood that the disclosure is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

### EXAMPLE

The coating system removal method of the present disclosure is illustrated in the procedure used to remove a coating system comprising a bond coat layer and a ceramic top coat from the high pressure nozzle guide vane shown in FIG. 2. The bond coat layer includes a MCrAlY intermetallic bond coating later.

The procedure comprises:
(a) Immersing the nozzle guide vane in a caustic solution of 46 to 54% potassium hydroxide or 46 to 54% sodium hydroxide;
(b) Maintaining the nozzle guide vane in the caustic solution at atmospheric pressure for a time equal to or less than one and a half hours at a temperature equal to or greater than 150° C. and equal to or less than 250° C.;
(c) Removing the nozzle guide vane from the caustic solution;
(d) Rinsing the nozzle guide vane in water at ambient temperature;
(e) Water jet blasting the nozzle guide vane by directing water at the ceramic top coat layer from a nozzle at a pressure of 275 to 296 MPa (40,000 to 43,000 psi), arranging the nozzle at a stand-off distance from the ceramic coating of 25 to 40 mm and traversing the nozzle over the ceramic top coat layer at a speed of 4 to 8 mm per second to remove the ceramic top coat layer and any thermally-grown oxide;
(f) Masking machined surfaces of the nozzle guide vane;
(g) Immersing the nozzle guide vane in an acid solution, e.g. HCl, to remove the MCrAlY intermetallic bond coating layer;
(h) Demasking the machined surfaces of the nozzle guide vane;
(i) Subjecting the nozzle guide vane to ultra-high pressure water jetting (UHPWJ) to remove the intermetallic bond coating from the platform surfaces of the component. The skilled person can determine the relevant UHPWJ parameters for the suitable equipment employed, e.g. water jet pressure, stand-off distance, traverse speed, nozzle orifice type, nozzle rotation and choreography of nozzle movements on platform surfaces, and the composition of the bond coating layer;
(j) Heat tinting the nozzle guide vane to ensure all MCrAlY intermetallic bond coating is removed. Any conversion of diffused Pt to Pt—Al cannot proceed unless all of the MCrAlY bond coating layer has been removed;
(k) Aluminising the nozzle guide vane to convert any diffused Pt within the bond coat layer to Pt—Al;
(l) Masking machine surfaces of the nozzle guide vane;
(m) Acid stripping and grit blasting the nozzle guide vane to remove any metal within the bond coat layer;
(n) Immersing the nozzle guide vane in nitric and/or sulphamic acid solution to remove any remaining aluminised material within the bond coat layer;
(o) Demasking the machined surfaces of the nozzle guide vane;
(p) Subjecting the nozzle guide vane to ultra-high pressure water jetting (UHPWJ) to remove the Pt—Al bond coating from all gas washed surfaces,. e. of the platforms and aerofoil surfaces. The skilled person can determine the relevant UHPWJ parameters for the suitable equipment employed, e.g. waterjet pressure, stand-off distance, traverse speed, nozzle orifice type, nozzle rotation and choreography of nozzle movements on platform surfaces;
(q) Heat tinting the nozzle guide vane to ensure all of the Pt—Al bond coating is removed;
(r) Visually inspecting the nozzle guide vane to check that the coating system has been removed; and
(s) Conducting one or more metallurgical assessments to check that the nozzle guide vane has not been damaged during the method e.g. any of the surfaces of the nozzle guide vane are pitted or otherwise damaged by chemical attack.

We claim:

1. A method of removing a coating system from a component that is coated with the coating system, the coating system comprising a bond coat layer and a ceramic top coat layer, the method comprising the steps of:
(a) immersing the component in a caustic solution of 46 to 54% potassium hydroxide or 46 to 54% sodium hydroxide;
(b) maintaining the component in the caustic solution at atmospheric pressure for a time equal to or less than one and a half hours at a temperature equal to or greater than 150° C. and equal to or less than 250° C.;
(c) removing the component from the caustic solution;
(d) rinsing the component in water;
(e) water jet blasting the component by directing water at the ceramic top coat layer from a nozzle at a pressure of 275 to 296 MPa (40,000 to 43,000 psi), arranging the nozzle at a stand-off distance from the ceramic coating of 25 to 40 mm and traversing the nozzle over the ceramic top coat layer at a speed of 4 to 8 mm per second to remove the ceramic top coat layer and any thermally-grown oxide;
(f) immersing the component in an acid solution;
(g) ultra-high pressure water jetting the component;
(h) aluminising the component to convert any diffused Pt within the bond coat layer to Pt—Al;
(i) acid stripping and grit blasting the component;
(j) immersing the component in a solution of nitric acid and/or sulphamic acid; and
(k) ultra-high pressure water jetting the component to remove any Pt—Al formed in step (h).

2. The method of claim 1, wherein any machined surfaces and/or any internal surfaces of the component are masked before the component is immersed in the acid solution in step (f) and the machined surfaces of the component are demasked before the component is ultra-high pressure water jet washed in step (g).

3. The method of claim 1, wherein the acid solution used in step (f) is a hydrochloric acid solution.

4. The method of claim 1, wherein the component is heat tinted after step (g) to indicate that all intermetallic material has been removed.

5. The method of claim 1, wherein in step (h) any diffused Pt within the bond coat layer is converted to Pt—Al by pack aluminising the component for 10 to 30 hours at 700° C. to 1050° C.

6. The method of claim 5, wherein in step (h) the component is pack aluminised for 16 to 22 hours at 800° C. to 950° C.

7. The method of claim 1, wherein in step (h) the component is heat tinted to indicate that all aluminised material has been removed.

8. The method of claim 1, wherein any machined surfaces and/or any internal surfaces of the component are masked before the component is aluminised in step (h) and the machined surfaces of the component are demasked before the component is ultra-high pressure water jet washed in step (k).

9. The method of claim 1, wherein in step (i) the component is immersed in hydrochloric acid at 40 to 60° C. for 5 to 15 minutes, and optionally subsequently immersed in an ammonium solution to neutralise the acid.

10. The method of claim 1, wherein in step (i) the component is grit blasted using a 220 mesh alumina grit at 0.14 MPa (20 psi).

11. The method of claim 1, wherein in step (j) the component is immersed in a solution of nitric acid for 20 to 40 minutes at 30° C. to 60° C., and optionally subsequently immersed in an ammonium solution to neutralise the acid.

12. The method of claim 1, wherein in step (j) the component is immersed in a solution of sulphamic acid for 20 to 40 minutes at 30° C. to 60° C., and optionally subsequently immersed in an ammonium solution to neutralise the acid.

13. The method of claim 1, wherein in step (j) the component is immersed in a solution of nitric acid and sulphamic acid for 20 to 40 minutes at 30° C. to 60° C., and optionally subsequently immersed in an ammonium solution to neutralise the acid.

14. The method of claim 1, wherein following step (k) the component is heat tinted to indicate that all of the coating system has been removed.

15. The method of claim 14, wherein the component is heat tinted at 700 to 800° C. for up to 20 minutes.

16. The method of claim 1, wherein the component is a gas turbine engine component.

17. The method of claim 16, wherein the gas turbine engine component is a high pressure turbine blade or a high pressure nozzle guide vane.

18. A method of repairing a component that is coated with a coating system, the coating system comprising a bond coat layer and a ceramic top coat layer, the method comprising the steps of:
(i) removing the coating system from the component by the method of claim 1; and
(ii) reapplying the coating system to the component to repair the component.
